(19) United States
(12) Patent Application Publication
(10) Pub. No.: US 2005/0081188 A1
(43) Pub. Date: Apr. 14, 2005

(54) Method and apparatus for providing integrated customer care and work-flow management

(76) Inventors: Anand R. Kumar, Bismarck, ND (US); Michael A. Frank, Mandan, ND (US); Connie L. Schaner, Mandan, ND (US); Kelley C. Kunnanz, Bismarck, ND (US); Brent Roberts, St. Peters, MO (US); William Frame, Sunriver, OR (US); Rex Moorman, Foristell, MO (US); Channon O. Lowman, Mandan, ND (US); Eric Burke, O'Fallon, MO (US)

Correspondence Address: BLACKWELL SANDERS PEPER MARTIN LLP, 720 OLIVE STREET, SUITE 2400, ST. LOUIS, MO, 63101, US

(21) Appl. No.: 10/735,470

(22) Filed: Dec. 12, 2003

Related U.S. Application Data
(60) Provisional application No. 60/511,154, filed on Oct. 14, 2003.

(51) Int. Cl. G06F 9/44; G06F 15/16

(52) U.S. Cl. 717/102; 709/202

(57) ABSTRACT

A system and method for providing integrated customer care, managing complex data relating to services and presenting information for selection and interaction by end users. The present invention delivers, tracks, presents and manages various aspects of customer care using a customer centric paradigm. An integrated macro-framework is utilized to provide a consistent and efficient single-point of entry GUI tool for accessing and navigating through various displays relating to the processing of data, reports, billing, work-flows, service orders and other aspects of customer care.

### CROSS REFERENCE

This application claims the benefit of U.S. Provisional Application No. 60/511,154 Filed Oct. 14, 2003.

### BACKGROUND OF THE INVENTION

1. Field of Invention

The present invention relates generally to computing environments. More particularly, the invention is directed to a system and method for providing integrated customer care, managing complex data relating to services, presenting information for selection and interaction by end users and managing work flows.

2. Background Art

An integral part of any organization is the customer service. Long after the initial sale, an organization must be able to keep its customers satisfied otherwise someone else will step up to the plate and successfully lure away the customer. Generally, the nature of a business dictates the level of interaction with customers. Service industries must deal with their customers on a more regular basis than manufacturers or other industry sectors. The energy and telecommunications industries are examples of such service industries. Critical to today's competitive environment is information. Whether it is responding to a consumer's request, analyzing rate change effects, or researching historical usage, a system is needed to provide detailed information that is needed for accurate and responsive decision making.

Every home or business utilizes one or more forms of energy or telecommunication services. As such, industries that provide these services tend to have a very large customer base, and have to handle a vast number of customer contacts in the form of telephone inquiries, point of sale contact and other electronic communiqué. What this means is that in addition to the periodic desire of those customers to make alterations to their services, there are also the ongoing interactions with the customers that involve billing questions, payment arrangements, service interruptions, equipment malfunction and so on. Customer service representatives (CSRs) have to cope with all of the very diverse needs of the customers.

The energy and telecommunication industries are plagued by varying aspects of customer service maintenance including traditional customer service issues, billing related issues, service agreement issues, and government regulation issues. Traditionally, system and business paradigms for addressing these customer service maintenance issues have been focused at the service level, or what is also termed the agreement level within this discussion. An agreement as used herein refers to a service offering. For example, a home with two telephone lines, electric service and gas service would be considered to have 4 separate agreements each of which pertain to the separate services.

As previously mentioned, customer service has traditionally been focused at the agreement or service level. By focusing customer service at the agreement level, it makes it extremely difficult if not impossible in some instances to pool or access consolidated information relating to a customer. For example, a telephone company records bills and accesses information by telephone number or location and not necessarily by customer. Similarly, an electric company accesses information by the physical location where the service is provided. In areas of the country where a single energy company, telecommunications company or cooperative provides multiple services, it is increasingly more difficult to get a handle on the entire position of a customer. It is very painstaking for a CSR to see the ‘full picture’ about a customer if the CSR must access agreements individually.

Accordingly, there exists a need for a collaborative and comprehensive solution that integrates all aspects of customer care, addresses consumer and subscriber billing, accounting, operations, product purchase, engineering and equipment, in order to enable a CSR to quickly and efficiently address customer needs. This is particularly more paramount because the success of any of these service-based businesses is heavily intertwined with its customer's perspective and the level of service that such customer receives.

Servicing a customer is another major challenge to a myriad of businesses. The objective is usually to provide quick, accessible and competent responses and solutions to the customer. To this end, in the utility or telecommunications industries, it is necessary to be able to quickly ascertain all of the facts and information pertaining to an individual customer or organization in order to fulfill work orders or service-orders.

For example, during the course of a telephone conversation or other communication between a CSR and a customer, it may be necessary to quickly determine the type of equipment that the customer has. Other useful information to a CSR might include the options that currently exist with that service or the options that may be available to the customer. In some cases, it may also be necessary to understand the impact and an implication of deregulation with regards to the customer's various accounts. Further still, a CSR should be able to quickly modify service options, reconnect disrupted services or access payment information pertaining to the customer. Even further, it would be advantageous to the CSR to be able to specify or access information relating to any service or work orders that may be relevant to the customer. A customer may well want to know when their service connection will occur, where their particular order is in the queue and so on. A CSR should be able to set up service orders and access status information regarding service orders.

Prior art systems that have attempted to address these issues have primarily consisted of solitary solutions to specific areas of concern. In other words, these prior art solutions have typically created ‘islands of automation’. For each island, certain functions are highly computerized and provide a solution, albeit a narrowly focused solution. However, this leads to problems of integration. The lack of interplay between the various systems requires that CSRs have to become conversant with multiple systems or rely on someone else to complete a task that relates to the customer with whom the CSR is communicating. From the organization's standpoint, there are usually a number of proprietary business tools from a multitude of manufacturers. Also many of the solutions historically have been character based, which provides a user interface that is not user friendly. Some graphical based systems have been implemented but are not customer centric and are not integrated and do not provide comprehensive workflow features.

Business tools from different manufacturers are often not compatible with each other. This results in integration, redundancy and implementation problems. In addition, there are the licensing and/or development costs associated with obtaining the tools as well as the maintenance costs, which could be quite prohibitive to some companies.

Accordingly, there exists a need for an improved customer care system that addresses the shortcomings described above. A fully integrated customer care system that provides a common interface to legacy system and facilitates access to customer information with a paradigm that is aptly suited and logical for traversing through the system is needed. A CSR should be able to access customer centered information, track customer contact, and manage work-flows relating to any jobs or service orders that arise from a customer contact.

### BRIEF SUMMARY OF INVENTION

The present invention is directed to a system and method for use in a computing environment to deliver, track, present and manage various aspects of customer care in a customer centric environment.

The present invention involves the use of integrated macro-frameworks that are called by the object oriented software code to provide a consistent and efficient graphical presentation. The frameworks also provide for efficient operations of the application as well as efficient access of database tables. The frameworks provide an efficient and consistent means for navigating through the various screens of a given customer care graphical user interface application.

In the preferred embodiment of the present invention, a customer care system is implemented. The embodiment of the customer care system is referenced herein as iVUE.

iVUE is a single-point of entry, GUI providing integrated access to various information technology solutions for the integrated processing of data, reports, billing and work flows, in a customer centric format. iVUE comprises many features and tools that allow an organization's CSR to efficiently handle all aspect of a customer's needs as they relate to the services provided by the organization. In order to demonstrate the flexibility and possibilities of iVUE, two embodiments of iVUE are described. The first embodiment involves a Customer Information System (CIS), an information technology solution directed to utility or energy provider organizations. The second embodiment involves a Subscriber Information System (SIS) for use by telecommunication service providers.

The CIS product includes among other things, location management, administration, reports and job management. CIS also supports diversification, deregulation and other billing options that pertain to the utility industry.

The SIS product integrates billing, accounting, service, agreement and other information. It provides access to, and management of, customer account status, history, service order and equipment purchase, in order to efficiently service the needs of customers.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1 is a network architecture diagram of a typical client-server environment implementing a graphical user interface;

FIG. 2 is an illustrative diagram of a client environment for practicing the present invention;

FIG. 3A is a diagram of the iVUE application architecture, illustrating its relationship to the Customer Information System and Subscriber Information System applications;

FIG. 3B is an illustration of a user interface in iVUE, depicting the component windows implemented in the present invention;

FIG. 4 is a diagram representative of the hierarchy and relationship of customer accounts and services in the present invention;

FIG. 5A is a screen shot of an exemplary user interface, which provides access to customer information in an embodiment of the present invention;

FIG. 5B is an illustration of the left navigation and alert windows of the user interface of the present invention;

FIG. 5C is an illustrative table such as might be displayed within the summary area of the user interface screen of FIG. 3;

FIG. 5D is an illustrative display of a window in which an administrator can define a customizable field for display on the user interface screen of FIG. 3;

FIG. 6A is a screen shot of an exemplary user interface, which provides access to account information in an embodiment of the present invention;

FIG. 6B is a screen shot of an exemplary user interface, which provides access to accounts receivable in an embodiment of the present invention;

FIG. 7A is a screen shot of an exemplary user interface, which provides access to general information on telephone service in an embodiment of the present invention;

FIG. 7B is a screen shot of an exemplary user interface, which provides access to local information on telephone service in an embodiment of the present invention;

FIG. 8 is a screen shot of an exemplary user interface that provides access to equipment management information in an embodiment of the present invention;

FIG. 9 is a screen shot of an exemplary user interface that provides access to location management information in an embodiment of the present invention;

FIG. 10 is a screen shot of an exemplary user interface that provides access to administration information in an embodiment of the present invention;

FIG. 11 is a screen shot of an exemplary user interface that provides access to job reporting in an embodiment of the present invention; and

FIG. 12 is a screen shot of an exemplary user interface that provides access to service orders in an embodiment of the present invention.

### DETAILED DESCRIPTION OF INVENTION

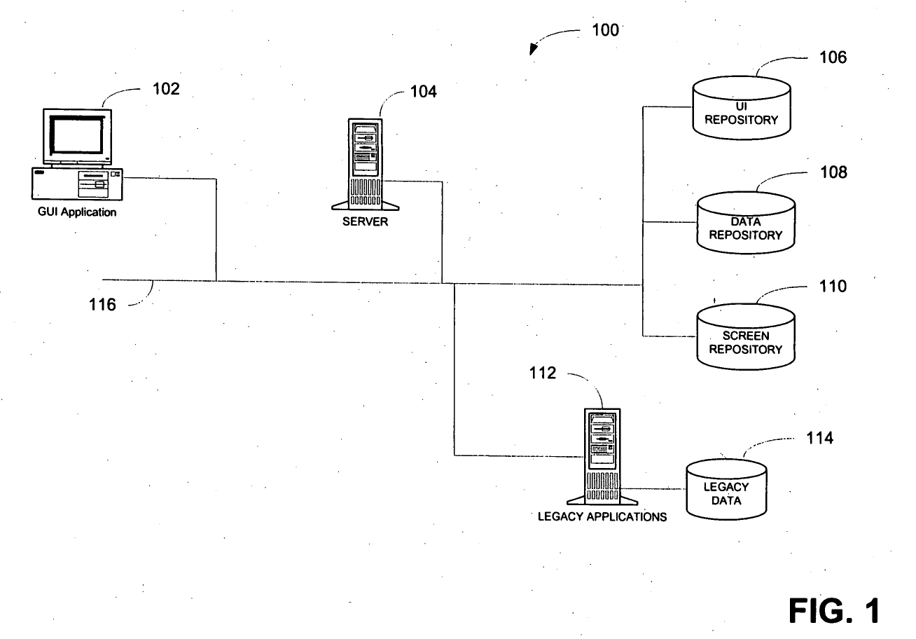

According to the embodiment(s) of the present invention, various views are illustrated in FIG. 1-12 like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

The present invention is directed to a system and method for providing customer care with an integrated customer centric tool. In the preferred embodiment of the present invention, the tool is provided in a client-server environment and utilizes an integrated development environment referred to as frameworks, which comprises repositories and XML based definitions. Frameworks is the subject of a separate United States application for Ser. No. ______, which is hereby incorporated by reference in its entirety. In brief, frameworks provides a set of macro-functions, data and user interface repositories that can be utilized in the development of various applications. The use of frameworks enables consistent presentation, operations and data handling across applications. Even further, frameworks provides an efficient and consistent means for navigation within applications. The present invention incorporates many features and tools that are based upon frameworks however, a detailed discussion on frameworks is beyond the scope of the present discussion.

In the preferred embodiment of the present invention, a customer care system is implemented. This embodiment of the customer care system is referenced herein as iVUE. It should be understood that the term iVUE is utilized to facilitate the discussion and is in no way intended to limit the present invention to any particular version or feature of the named product.

iVUE is a single-point of entry, GUI providing integrated access to various information technology solutions for the integrated processing of data, reports, billing and work flows, in a customer centric format. iVUE comprises many features and tools that allow an organization's CSR to efficiently handle all aspects of a customer's needs as they relate to the services provided by the organization. In order to demonstrate the flexibility and possibilities of iVUE, two embodiments will be described in this document. The first embodiment involves a Customer Information System (CIS), an information technology solution directed to utility or energy provider organizations. The second embodiment involves a Subscriber Information System (SIS) for use by telecommunication service providers. The embodiments can be utilized separately or combined into one integrated application. The two embodiments while having unique features have a consistent look and feel as made possible through the use of the frameworks.

The CIS product includes among other things, location management, administration, reports and job management. CIS also supports diversification, deregulation and other billing options that pertain to the utility industry.

The SIS product integrates billing, accounting, service, agreement and other information. It provides access to, and management of, customer account status, history, service order and equipment purchase, in order to efficiently service the needs of customers.

Having briefly provided an overview of the present invention, the one embodiment of the invention will be discussed with reference to FIGS. 1-X. An exemplary operating environment for the present invention is first described below.

The details of the invention and various embodiments can be better understood by referring to the figures of the drawing. Referring to FIG. 1, a functional diagram of a typical client-server environment 100 implementing a graphical user interface is shown. A typical client 102 is shown interfacing with a typical server function 104. The server 104 interfaces with a bank of repositories 106. The bank of repositories includes a user interface (UI) repository 112, a Data Binding Repository 114 and a Screen Repository 116. The server and repository functions interface with legacy application 118 and a legacy database 120. The graphical user interface applications 110 are shown resident at the client site. The user interface 108 provides graphical user interface screens as well as a data entry capability. The integrated repositories 106 allow the graphical user interface application 110 to run more efficiently and provide a rich graphical presentation having a consistent look and feel. The graphical user interface application is also able to interface to various legacy applications and legacy databases by utilizing the integrated repositories to provide much of a data handling functionality. The various repositories are linked to various object oriented applications that execute at run time to perform much of the data binding and field definition functions as well as screen arrangement. The graphical user interface application triggers execution of the repository functionality as well as imports data and graphical information in order to generate the graphical user interface.

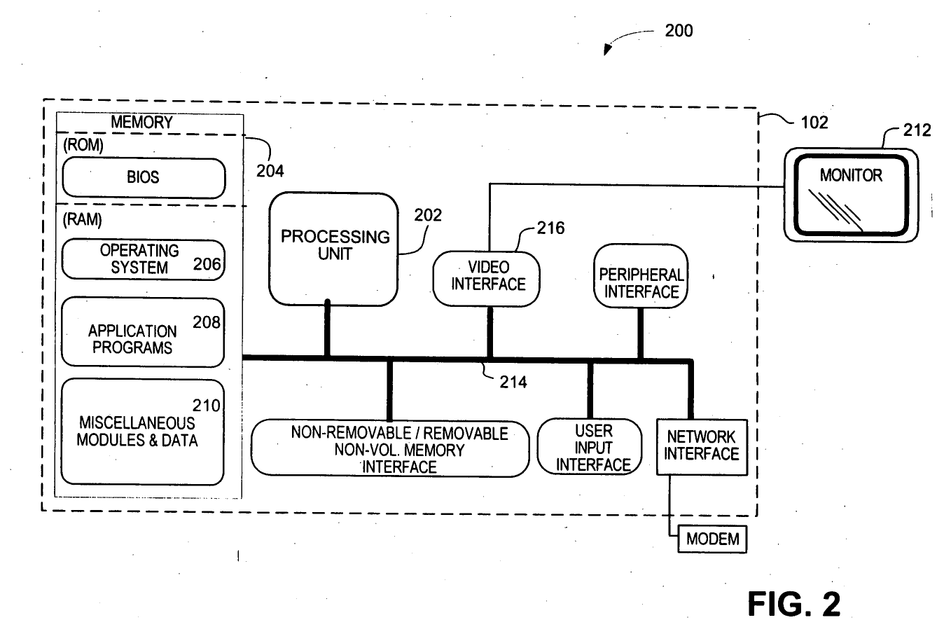

Referring to FIG. 2, an example of a suitable computing system environment 200 in which the invention may be implemented is illustrated. The computing system environment 200 is only one example of a suitable computing environment and is not intended to suggest any limitation as to the scope of use or functionality of the invention.

In that regard, the present invention may be described in the general context of computer-executable instructions, such as program modules, being executed by a computer. Generally, program modules include routines, programs, objects, components, data structures, etc. that perform particular tasks or implement particular abstract data types. Those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. When operating in a distributed computing environment, program modules may be located in both local and remote computer storage media including memory storage devices. Additionally, various functions that will be described herein may be implemented by modules that exist wholly or partially on a client system or a server.

The computing environment 200 should not be interpreted as having any dependency or requirement relating to any one or combination of components illustrated in the exemplary operating environment 200.

With reference to FIG. 2, an exemplary system 200 for implementing the invention includes a general purpose computing device in the form of a computer 102 including a processing unit 202, a system memory 204, and a system bus 216 that couples various system components including the system memory to the processing unit. Importantly, the variant of the computer 102 utilized as the client PC must support a playback mechanism and data rates suitable for high end image rendering.

Computer 102 typically includes a variety of computer readable media, which may comprise computer storage media and communication media. The system memory includes computer storage media in the form of volatile and/or nonvolatile memory such as read only memory (ROM) and random access memory (RAM). A basic input/output system (BIOS), containing the basic routines that help to transfer information between elements within computer 102, such as during start-up, is typically stored in ROM. RAM typically contains data and/or program modules that are immediately accessible to and/or presently being operated on by processing unit 202. For illustrative purposes, FIG. 2 depicts operating system 206, application programs 208, and other miscellaneous program modules and data 210.

The computer 102 may also include other removable/non-removable, volatile/nonvolatile computer storage media. Such removable/non-removable, volatile/nonvolatile media may include a hard disk drive, a magnetic disk drive, an optical disk drive, a CD ROM or other optical media. Other removable/non-removable, volatile/nonvolatile computer storage media that can be utilized include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 1021. A user may enter commands and information into the computer 102 through a variety of input devices including but not limited to a keyboard, pointing device, scripting interface, a microphone, joystick, game pad, satellite dish, scanner, or the like. These and other input devices may be connected by other interface and bus structures, such as a parallel port, game port, fire-wire, or a universal serial bus (USB). A monitor 214 or other type of display device is also connected to the system bus 214 via an interface, such as a video interface 216. The computer 102 may also include output devices such as speakers, printers, and the monitor 212, which may be connected through a peripheral interface.

The computer 102 in the present invention operates in a networked environment using logical connections to one or more remote computers. The remote computer(s) may be a personal computer, and typically includes many or all of the elements described above respecting the computer 102. The computer 102 illustrated in FIG. 2 may include connections to a local area network (LAN), a wide area network (WAN) or other networks including the Internet.

When used in a LAN networking environment, the computer 102 is connected via a network interface card (NIC) or adapter. When used in a WAN networking environment, the computer 102 may include a modem or other means for establishing communications over the WAN. In a networked environment, program modules discussed or depicted relative to the computer 102 or portions thereof, may reside in remote memory storage or across multiple devices. It will be appreciated that the network connections shown are exemplary and other means of establishing a communications link between the computers may be used.

Those of ordinary skill in the art will appreciate that there are several other components and interconnections present within a computing environment such as computer 102 and these are well known. Accordingly, additional details concerning the internal construction of the computer 102 will not be discussed in connection with the present invention.

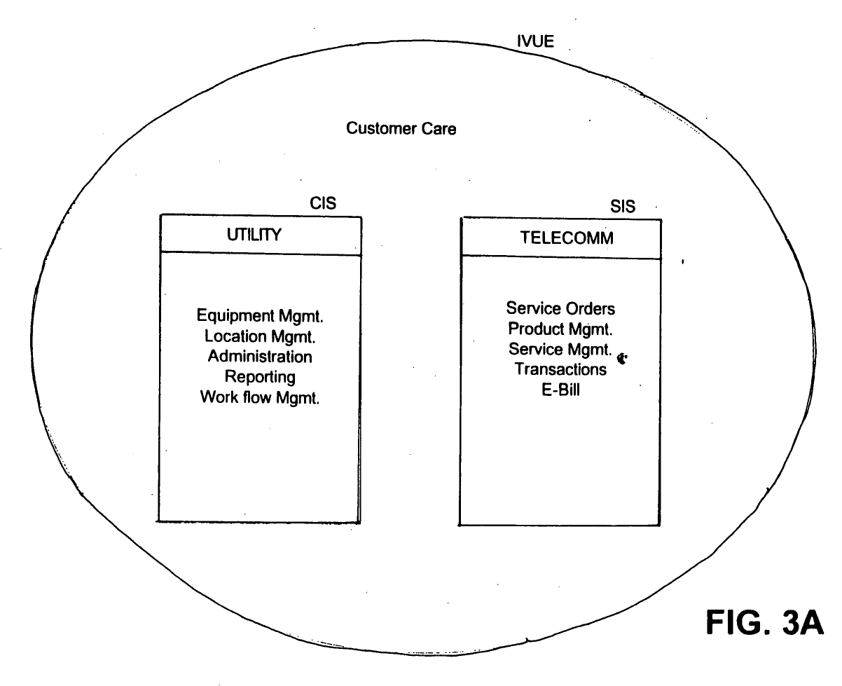

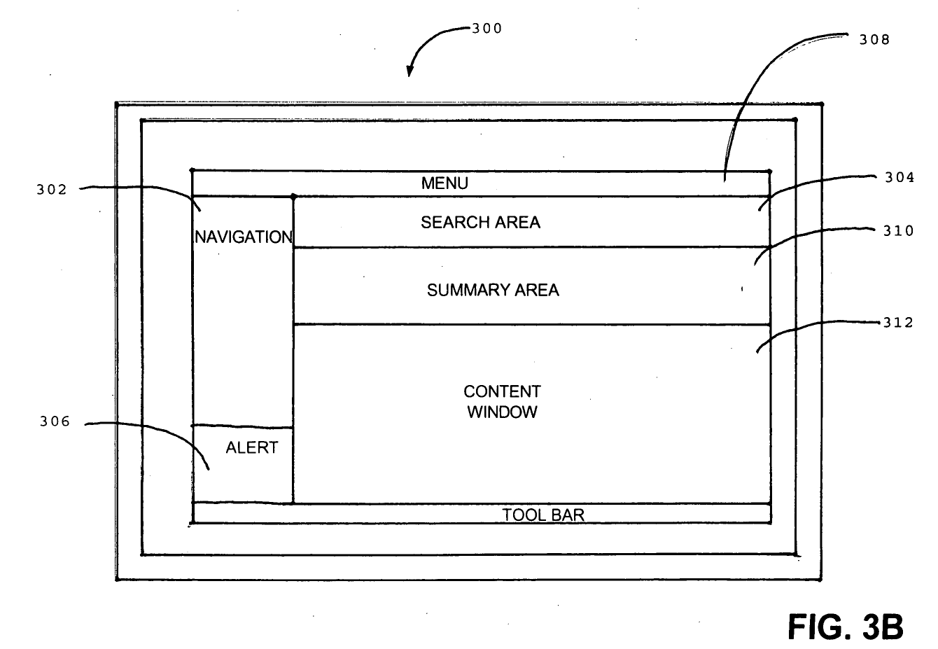

Having provided a broad overview and introduced the environment, devices and nomenclature, the process of the present invention can better be understood and will be discussed with reference to flow diagrams and screen illustrations in FIGS. 3-12

FIG. 3A illustrates the relationship of CIS, SIS and iVUE. Both CIS and SIS are applications that implement various features of iVUE in addition to providing some unique options which are particularly suited for their respective industries.

iVUE provides through the implementation of frameworks, a customer centric care system that integrates customer tracking accounting and billing functions, simplified navigation and end user customization. iVUE further provides consistency of integration to legacy systems.

As illustrated, CIS couples the functions of iVUE with work flow management and other features to provide a technology solution for the utility industry. SIS on the other hand couples iVUE with customer service solutions including accounting functions and service implementation management.

Certain aspects of the CIS and SIS applications share a common theme. In particular, CIS and SIS share the highly intuitive customer centric view featured by IVUE, through its graphical user interface and integrated customer care solution.

Referring to FIG. 3B, a graphical user interface (GUI) generally utilized in the present invention is illustrated and referenced as display 300. The present invention is described with reference to a single point of entry and GUI that provides access to a variety of solutions for an integrated customer centric environment. It would be understood by one skilled in the art that the illustrative windows and arrangement of the GUI can vary in content, without departing from the scope of the present invention.

As previously discussed, a predominant aspect and feature of the present invention is the customer-centered paradigm. To this end, the GUI windows for content display, navigation and general information presented to the CSR are designed and provided to further, quick, detailed access and display of relevant customer information. It should be understood that while the present invention is described with reference to a CSR, such reference would equally be applicable to any other operators or interface programs that interact with iVUE. The term operators can include a customer who is utilizing an interface device or system to access the customer care system of the present invention. One example of such interaction may be through a web browser over the internet.

The GUI interface of iVUE includes screens that generally conform to the illustrated application screen of display 300.

As shown, display 300 provides a dynamic user interface having some very specific window areas. The window areas include a navigation window 302, a search window 304, an alert window 306, a menu window 308, a summary area 310 and a content window 312. Each of these window areas provides a CSR with data or options that facilitate the task of customer care. The details of the content of these windows are best understood by reference to specific screens in the exemplary iVUE application and a discussion on the customer centered paradigm.

As discussed earlier, iVUE is a customer centric program which include features that facilitate ease of navigation, delivery of solutions to customer needs and interaction with legacy systems while also enable contact tracking and reporting. The CSR can access all information in a customer centric format through the single point of entry customer care environment without exiting the environment to access other applications such as billing. With this customer centric single point of entry environment there is no need to segment your CSRs, for example CSRs who address billing questions segmented from CSRs who add, cancel, or modify service agreements. All CSRs will have single point of entry access and the right graphical user interface makes the application more intuitive to use thereby reducing the learning curve of the CSR and allowing a given CSR to service all needs. An individual or organizational customer is the focus and hub for reference and access to the operations provided by the system. The definition of a customer may vary across environments. Within the consumer environment a customer may be an individual. However, within the business environment a customer may be a business unit, a subsidiary or other business entity. Data retrieval, display or collection is centered around the customer. As such, all interaction begins with the customer.

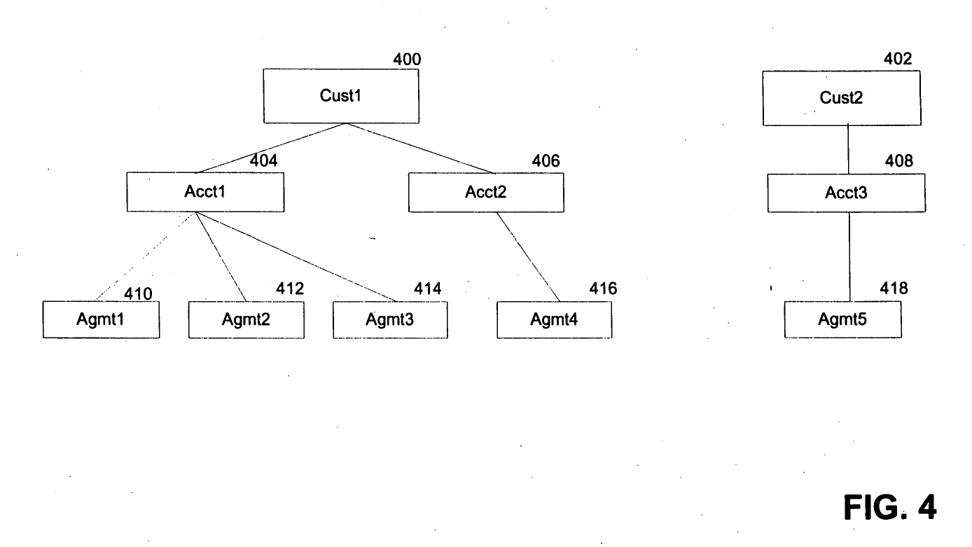

The customer centric paradigm of the present invention defines a certain relationship between a customer and the other system identifiers that relate to the customer's service. Referring to FIG. 4, a diagram representative of the hierarchy and relationship of the various identifiers of the present invention is illustrated. As discussed earlier, iVUE is customer centric. This means that the iVUE customer care application implements a hierarchy that is focused on the customer. As shown, a customer 400, 402 is the top level of the hierarchy. A customer is identified within the invention by a unique qualifier such as a customer number. The customer number may be randomly generated or assigned. The customer number also identifies some personal information about the customer. A customer can have one or more accounts 404, 406, or 408.

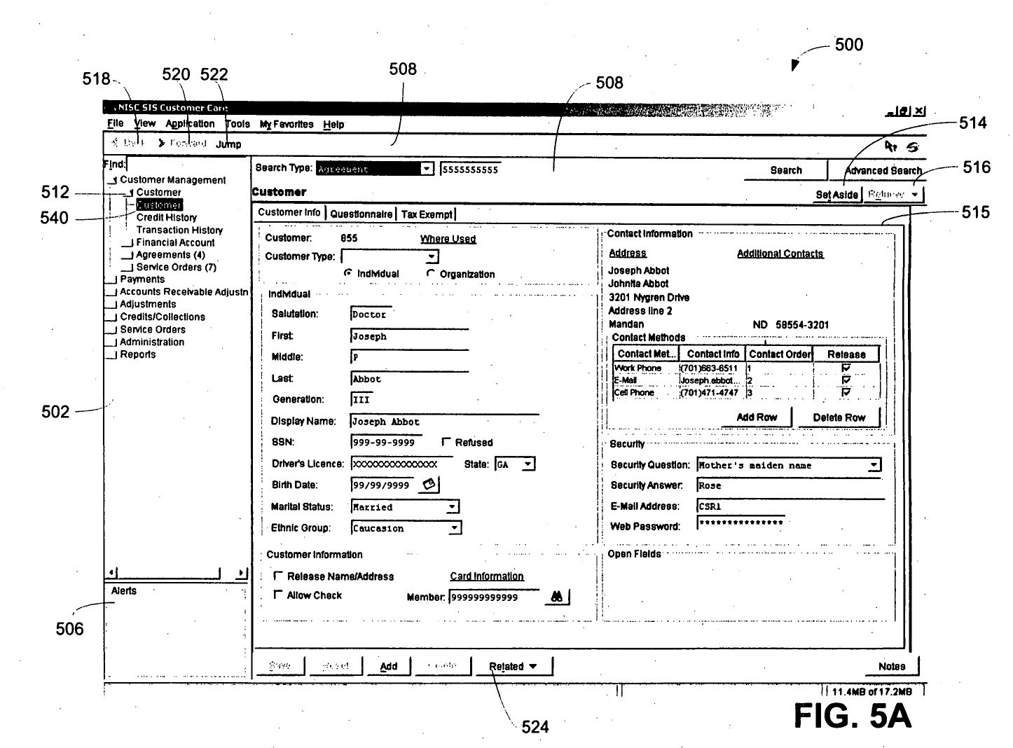

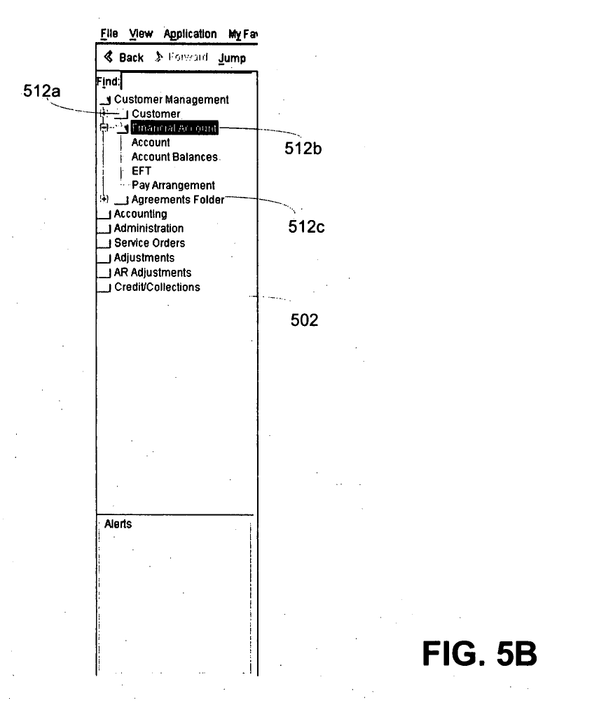

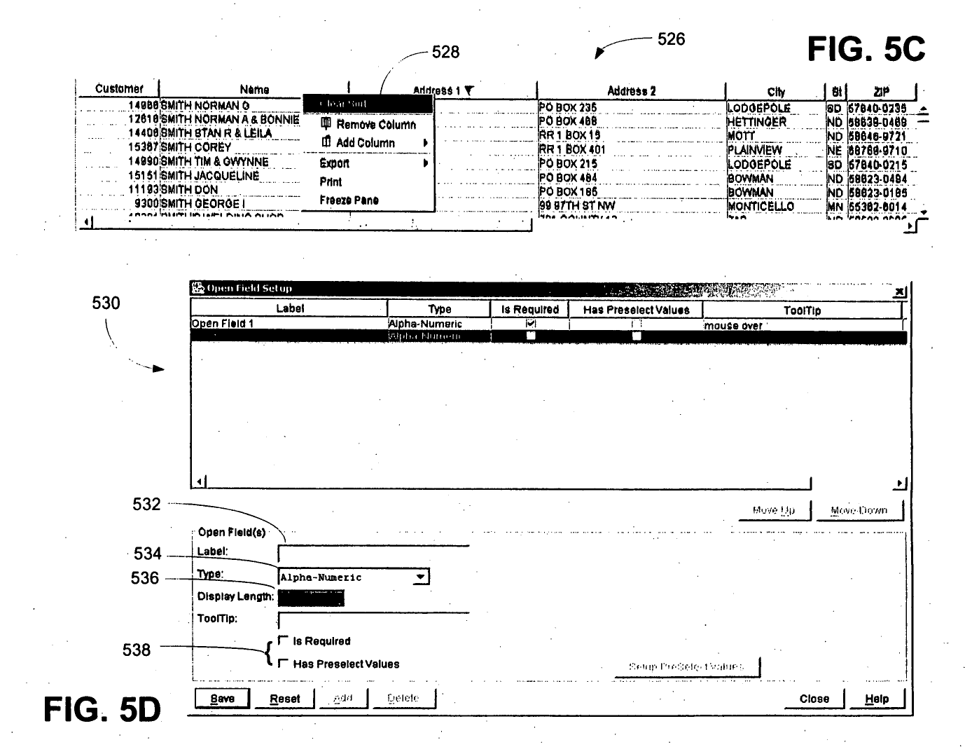

The account level 405, 406, and 408 establishes the billing level for a particular customer. For example, a first customer cust1 400 has a first account acct1 404 and a second account acct2 406. This means that two separate bills will be generated for cust1 400. On the other hand cust2 402, which has only one account acct3 408, will receive only one bill, which is associated with acct3 408. For each account there can be one or more services or agreements. In the context of a telecommunications application, an agreement represents a service such as telephone, wireless, cable television (CATV) or internet. In the context of a utility application an agreement or represents gas, electric and so on. As shown, Acct1 404 has three separate agreements agmt1 410, agmt2, 412 and agmt3 414. All three agreements will be billed to acct1 404. The bill for Acct2 406 will reflect the charges associated with agmt4 416. In a similar manner, acct3 408 will reflect the charges of agmt5 418 for cust2 402. Access to agreements, accounts and customers are available through a customer care screen. A customer care screen provides some of the relevant demographic data and means to navigate and search the system. An exemplary screen display 500 of the GUI that is presented to a CSR regarding a customer is shown in FIG. 5A. By providing a particular piece of customer identification information as a search criterion or through other such means, a CSR is able to obtain detailed information about a particular customer—a focus customer. For the purpose of clarity and to aid the understanding of the present discussion, a current customer being handled by the CSR or other operator of the customer care system is referred to as a focus customer.

In connection with access to customer information, display 500 includes several of the window areas described earlier and illustrated in FIG. 3B. Returning to FIG. 5A, a navigation window 502, provides a tree display of options and screens that are available to the CSR. The tree display comprises nodes and related sub nodes. The nodes or sub nodes are available to a CSR for selection and navigation. A CSR is able to move through the system, display screens and access the information identified by the displayed node or sub-node labels. A more detailed view of the navigation window 502 is illustrated in FIG. 5B.

As illustrated in FIG. 5B, certain categories of information have been defined and identified as nodes 512 within the tree display of the left navigation window 502. As shown, there can be sub nodes 540 associated with the nodes 512. Access to various actions and information can be accomplished by navigating the system using the nodes 512 or sub nodes 540. The selection of a node 512 will result in the presentation of an associated window or the display of one or more related sub-nodes 540. In the case were sub-nodes 540 are displayed, the sub-nodes 540 can then be selected by the CSR to access an associated window of information. As shown in FIG. 5B, nodes 512 or sub nodes 540 may provide access to customer management features including customer 512a, financial account 512b or agreements 512c. The financial account node 512b may further have sub nodes 540 including account 540a, account balance 540b, EFT 540c or payment arrangement 540d. An alert window 506 provides notification of specific criteria or status that may be of interest to a CSR, in regard to the focus customer. Other alternative navigation means are available, as outlined below.

Returning to FIG. 5A, the selection of a node 512 or sub-node 540 results in a change within the content window 510. Importantly, any selection of a task, view or action from within the navigation window 502 or content window 512, results in a display of associated information that pertains to the focus customer. The menu window 508 presents a user with means to quickly navigate between screens. For example, the ‘back link’ 518 and ‘forward link’ 520 allow a user to navigate to a previous screens in much the same way as similarly identified buttons on internet browsers. A ‘jump link’ 522 enables quick navigation to screens, which the user can specify by name.

During the setup of an iVUE system, by someone with appropriate security access, display screens can be assigned short identifications or nicknames. The nicknames or identification may then be used to invoke those screens from the “jump link” 522.

A ‘set aside’ button 514 and a ‘retrieve’ button 516 allow a user to set work aside without having to save the current operation. In other words, the application of the present invention allows a CSR to multi-task by temporarily placing a current operation aside to work on another operation. The CSR can then return to the previously set aside operations and continue where they left off. There is no limit to the number of screens that can be set aside and the screens that are set aside can be recalled in any order.

Also available on the screen 500 is a related button 524. Selection of the related button 524 provides quick navigation to a screen that a CSR would most likely be interested in viewing. In other words, certain displays may be pre-configured as being related to one another, thus allowing quick access. For example, a payment history display may be configured as the related screen to the customer account display screen.

Also available are various hyperlinks. The hyperlinks cause the screen 500 (document viewer) to display a different view of either the same set of information or a different set of information. The hyperlinks further enable a high level of interaction, thus allowing a much more complex structure of screens and information to be traversed quickly and efficiently by a CSR.

Referring to FIG. 5C, a table 525, which may be displayed within a summary area of a user interface screen is shown. Certain information about a customer such as a list of accounts or agreements may be illustrated in a tabular display. The present invention enables a user to customize such tables by adding or removing columns at run time. The fields of the table can also be sorted and individual panes can be frozen to allow panning. A selection of such features can be made through a menu 528.

Another feature of the present invention is the availability of open and customizable fields on most screens. Referring to FIG. 5D a display of a window in which an administrator can define a customizable field for display on the user interface screen is shown. The user interface screens of the present invention are customizable by end users that have the appropriate security access. Since it is very likely that not all fields that an organization may need could be anticipated and provided by the developers of iVUE, open fields which can be customized and incorporated into the application are provided as an added convenience and feature of iVUE. A label 532, type 534, display characteristics 536 and validation requirements 538, for an open field can be readily configured by an end user using an open field window 530 as illustrated.

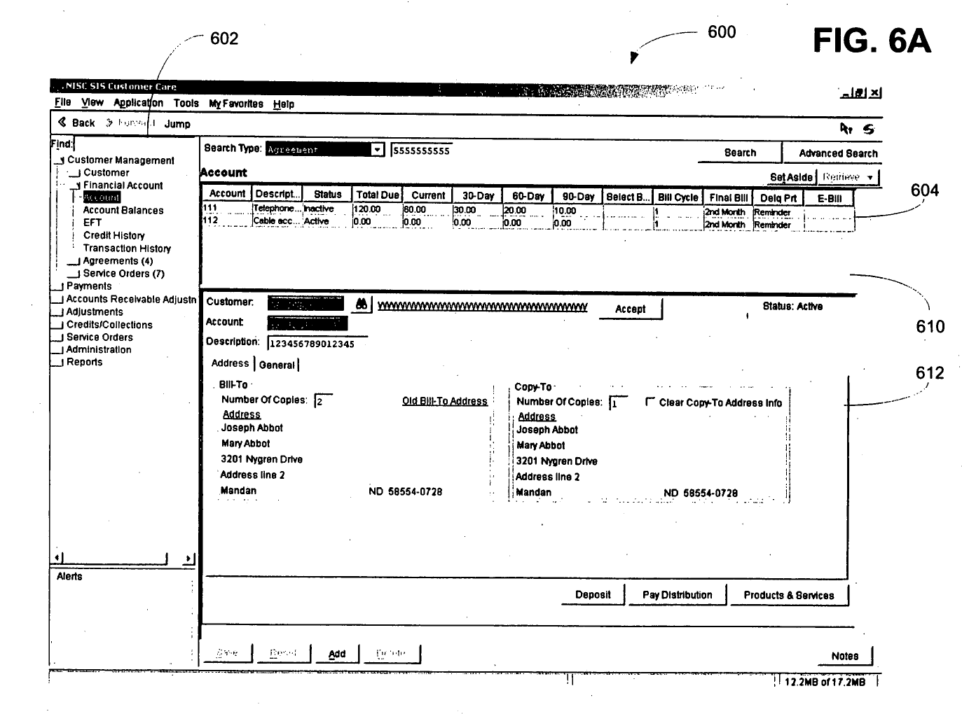

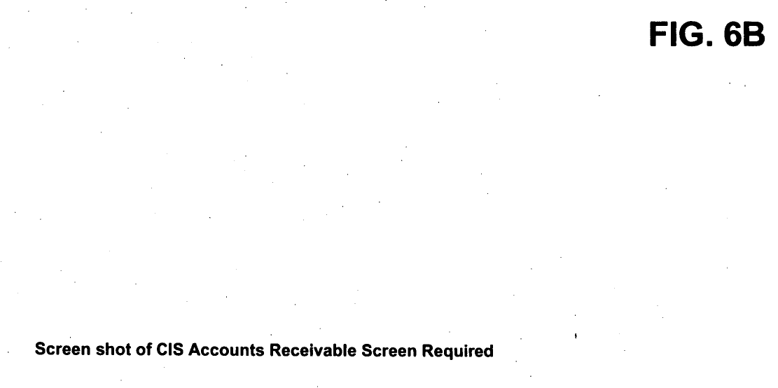

As previously discussed, account is the next level in the hierarchy of the customer centric solution of iVUE. Account information for a customer can be accessed by a CSR in the same manner that customer identification information can be accessed through the same single point of entry. FIG. 6A illustrates an exemplary user interface that provides access to account information. The display 600 is similar in appearance to the displays of the previously discussed figures; in so far that it contains similar windows. Within the navigation window 602, the sub-node ‘Account’ is shown as being selected. This results in a display of account information for the focus customer in the content window 612. A CSR can make changes or access the billing address of the displayed account and other related information pertaining to the account such as, deposits, payment distributions or the underlying products or services. One distinct difference in the display 600, is the table 604 that is shown in the summary area 610.

A tabular display is utilized in iVUE to convey summary information. As previously discussed, a customer can have multiple accounts. In the displayed scenario, the customer has two accounts having accounts numbers 111 and 112 respectively. These accounts along with their associated summary information are displayed in the table 604. The tabular information displayed about an account can include a description, status and the receivables aging information. A CSR can access further details about any of the information displayed in the table 604.

Referring to FIG. 6B a screen shot of a more detailed display of accounts receivable, is shown. A CSR can drill down into more detail about the receivables associated with an account, by selecting the appropriate node in the navigation window 602 of FIG. 6A. Returning to FIG. 6B, display 614 includes the typical windows of the iVUE application. However, as would be expected, the displayed information is quite different particularly within the content window 616, where aging, provider and other such information about the account receivables can be accessed.

In addition to the various features of iVUE discussed thus far, each customer, account, agreement and activity related to those entities can be associated with notes that are created by a CSR. The notes are stored with the appropriate record and can be utilized to convey additional information for which a field does not exist within the iVUE system. For example, the notes may contain an explanation for a given alert condition that arises concerning an account, such as, the fact that the customer has made contact and has arranged to stop in to make a payment.

Thus far, various features of iVUE have been described. Additional features will be further described with reference to the CIS and SIS implementations. In particular, the agreement/service levels of the customer centric hierarchy will be described for each of the applicable industries. Other features and options that are unique to each industry implementation will also be briefly described.

Customer Information System

As previously illustrated in FIG. 3A, the Customer Information System (CIS) is an integrated, configurable multi-product customer care and billing solution that is directed to the utility industry. Within this implementation of the iVUE product, equipment management, location management, administration and reporting are some of the features that are relevant and specific to the industry and its client base and thus available to a CSR.

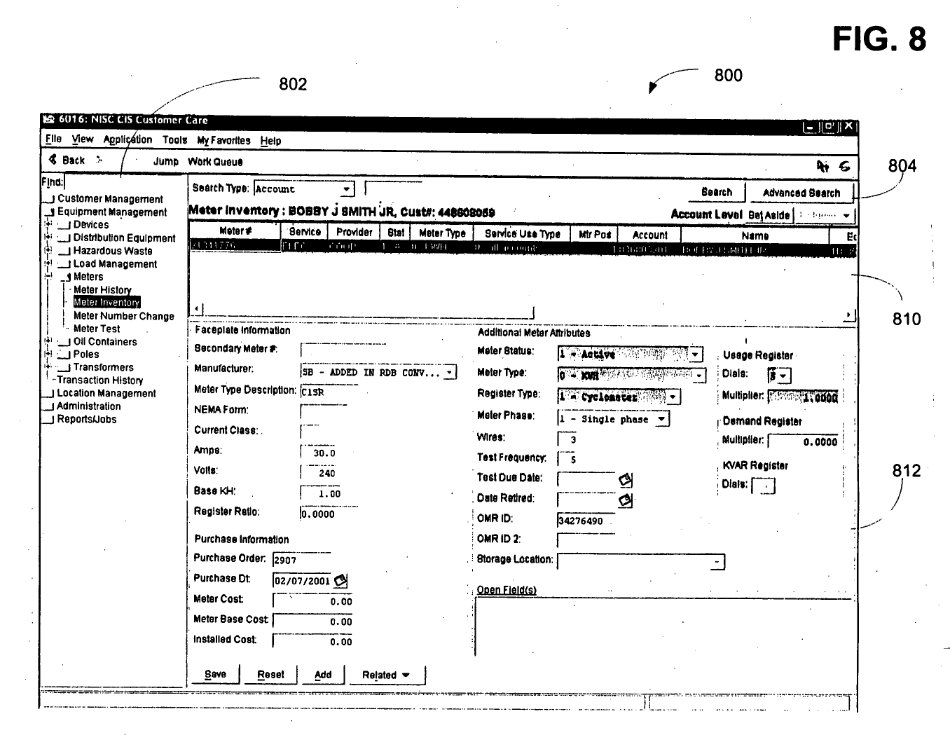

Turning initially to equipment management the screen shot of FIG. 8 illustrates the options and information that may be available to a CSR in connection with the selection of ‘meter inventory’, a sub-node of equipment management. As described in connection with the screen template 300 (FIG. 3A) of the iVUE product, the screen 800 of FIG. 8 includes a navigation window 802, a search area 804, a summary area 810 and a content window 812.

The summary area 810 displays a table that includes a row of summary information pertaining to a meter. The meter is associated with the customer that was being processed by the CSR at the time when equipment management was selected. Detailed information about the meter can be accessed in the content window 812.

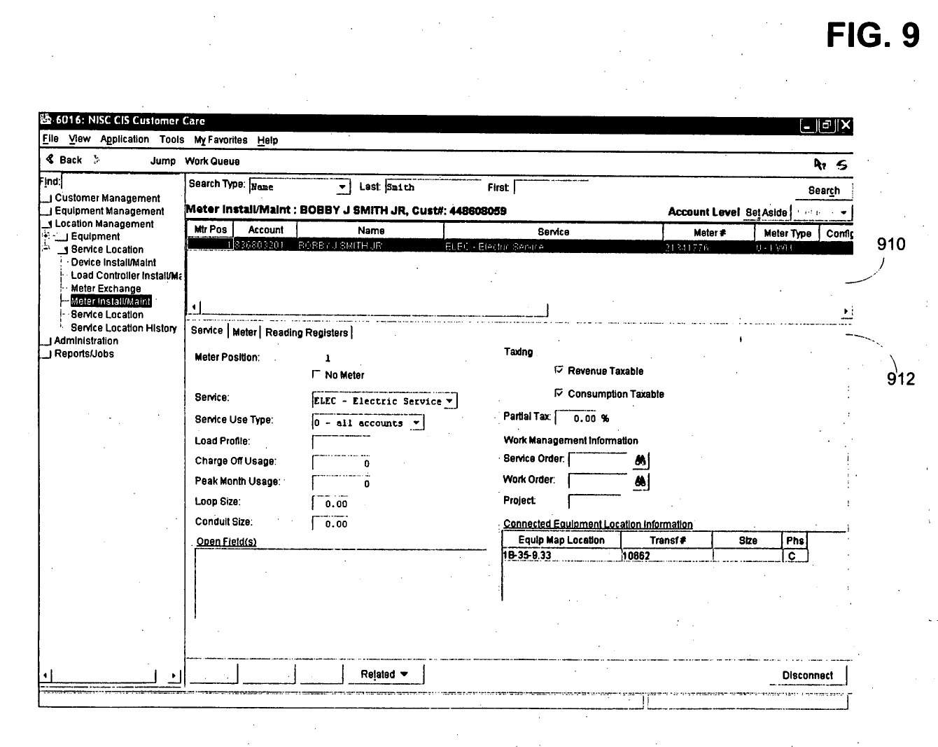

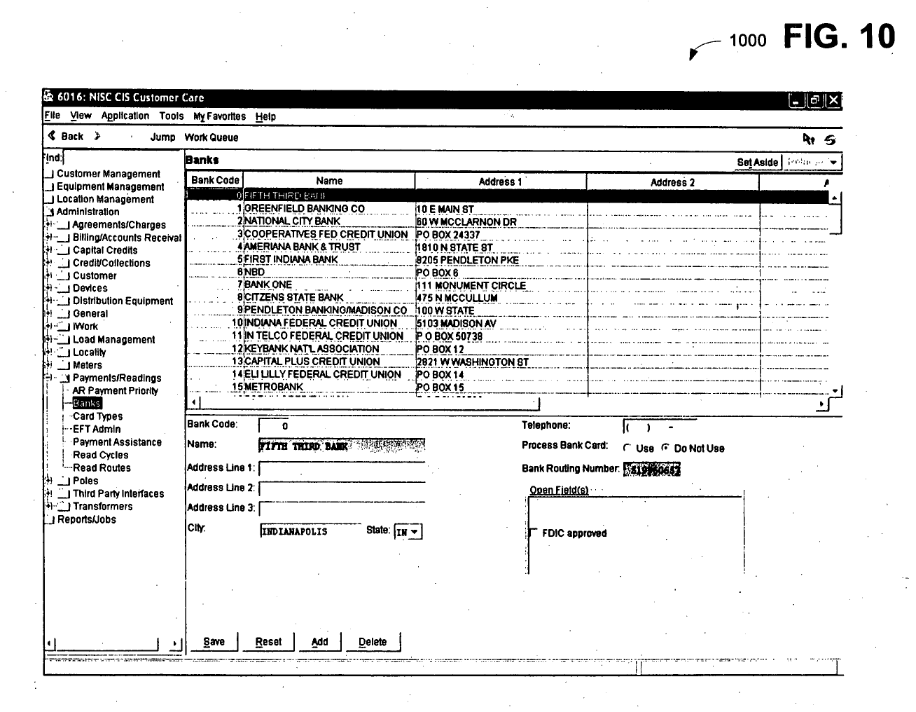

Location management is configured and accessed through a screen such as shown in FIG. 9, wherein information relating to the location of the meter of FIG. 8 is displayed. Here again is another example of the link and connectivity between related aspects of the customer care that is characteristic of the CIS product. Because a particular meter is associated with a customer, when a CSR selects location management, information that is relevant to that meter of the customer is displayed both in the summary and a 910 and content window 912. Given the appropriate security level, a CSR can then modify such information.

Administration of the CIS application is accessible to persons with appropriate security. Aspects of the appearance, system requirements and behavior of CIS can be specified by an end user organization such as an energy provider company. An example of such administrative capability is illustrated in the screen display 1000 of FIG. 10. As shown in the screen display 1000, for example, an energy provider can access a list of banks along with other information pertaining to a bank and the energy provider's interaction with that bank. As shown in the CIS implementation of the present invention, routing codes, telephone numbers and bank card information can all be accessed through the CIS system.

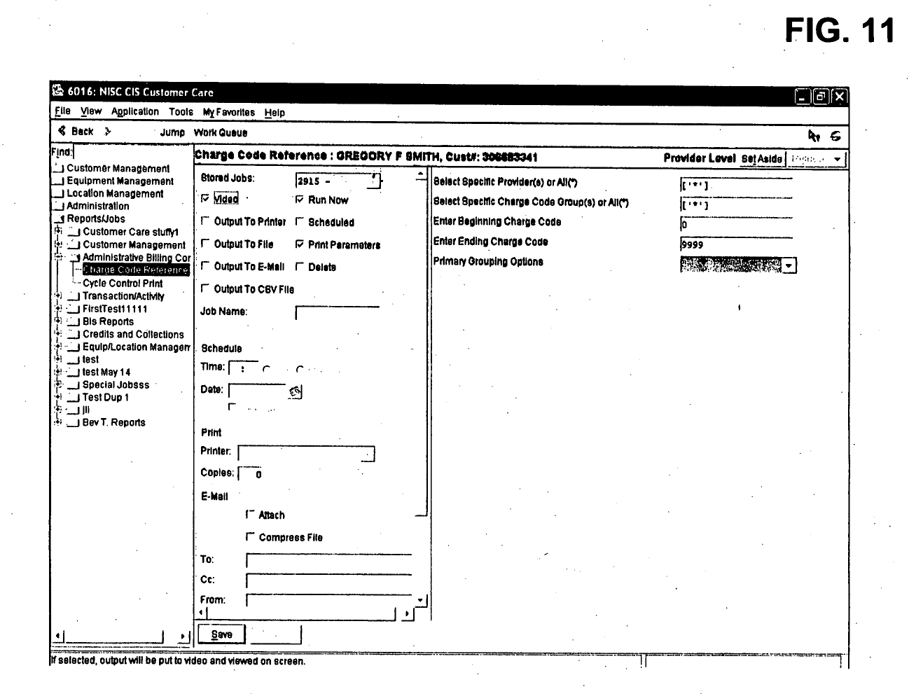

Reports of various types may both be administered and produced through the CIS application. In an embodiment of the present invention, Crystal Reports (a third party general purpose reporting software package) is integrated into CIS. The end users are able to configure and specify attributes and behavior of the report. An exemplary GUI for interacting with such reports is illustrated in FIG. 11. As shown, the end user has control and the ability to specify such things as the destination of reports, a schedule for the execution of the report. An end user can also incorporate custom fields that were not previously provided in the pre-designed reports.

CIS includes a flexible work management system. Specific tasks that arise from a customer contact may be itemized and tracked within the system. Tasks may also originate from specific order requests by a CSR or as a consequence of other action by a CSR. In either case, CIS manages such tasks through a work queue. A work queue provides a view of outstanding tasks, including any filters related to the tasks. A filter for example may limit the view of tasks to those that are assigned to a given resource or those that have a particular status.

The work flow system classifies all tasks as belonging to one of three categories. A first category of tasks is assigned to a specific resource, which could be a work unit, an individual and so on. The second category are print tasks, which include such things as reports. The third category are system tasks, which are able to initiate a process or launch a particular display or application.

Tasks include a defined default, which can include special or specific information or instruction. These defaults are alterable by an end user with appropriate security access. Workflow templates may be developed using these default tasks. The templates essentially connect individual tasks. A workflow may be further defined to include a reason for the customer's contact i.e. the set of events that initiated or led to the creation of the workflow. In that regard, reason codes or specific reason texts may be provided by a CSR and associated with a workflow.

Accounts receivables (A/R) can be accessed through CIS. An A/R screen provides details of a customer's status with line item breakdowns beyond just the current, 30-day, 60-day and 90-day totals. Information about the original invoice/bill including the balance and paid items from a particular invoice are accessible. Even further, A/R priority can be specified for a customer. In other words, CIS allows the designation and identification of where payment amounts should be applied when partial payments are made. This feature is enabled by the presence of control records within the application.

Control records provide the flexibility that is needed to deal with deregulation issues. In the case of a customer that has multiple providers, the control records enable selection of charges that should be posted to the various accounts of a customer. Even further, the control records facilitate prioritization of payment, which can occur at the charge code level, by service or by account. For example, this feature of CIS allows a party that is in receipt of a customer's money to pay on a 90-day account of an energy provider before paying on the 60-day account of a cooperative.

Credit history of a customer can be tracked and utilized within CIS. Traditionally, fourteen different events relating to a customer can be tracked, e.g. bounced checks, meter tampering etc. CIS allows an organization to further define additional credit criteria or events, and assign weighting to each of such events. In conjunction therewith, a monthly credit rating may be computed, using the individual events and weighted values. The monthly credit rating is a twelve month average. In an embodiment of the present invention, award values are then provided for various credit ratings, e.g. Gold, Silver etc. These award values may then be utilized to provide incentives to the customer. A historic view of all the data that went into computing credit histories is available for review, i.e. a twelve-month period of weightings and events.

Payment arrangements can be tracked and information pertaining to such arrangements is integrated into other billing functions of CIS. For example, through CIS a CSR can provide on-screen overrides of cutoff due dates. Credit history information can be updated in conjunction with such arrangements. Verification of compliance with the payment arrangement can also be tracked; thus further enabling the automated override of system generated delinquent dates. CIS allows the specification of long range payment arrangements rather than just isolated single instance arrangements. In other words, the system calculates and builds schedule of payments and incorporates that into the routine billing, while also flagging the appropriate delinquency tracking modules. Coupled with all of this is a robust system for designating when and to what accounts or entities, payments should be applied.

CIS provides a number of other features that further the goal of complete customer care and access to information by CSRs. For example, CIS provides a photographic view to a CSR, of the actual bill that was sent to a customer, rather than mere totals or summaries. CIS supports the ability to maintain and utilize seasonal addresses and primary addresses for the mailing of bills. In order to facilitate training of CSRs, CIS provides a feature that facilitates the building of a test environment. A sampling of records can be easily specified to generate an environment that will create records that are necessary to train CSRs in such things as new rates, new bill changes and so on.

Caller Id functions provided through a telephone service provider is one of the features that is integrated into CIS. Through the integration of Caller Id, a greater convenience is afforded to both CSRs and calling customers. In operation, the CIS product can integrate with phone switches that are capable of passing information on calls including the phone number and user's port. When a call is placed to the CSR's port, a Caller Id Screen 1302 as shown in display 1300 of FIG. 3A is presented to the CSR. The Screen 1302 indicates the customer's name and phone number. The customer's name is actually looked up in the CIS personal record database by phone number. The CSR has several options from this point. One option is to select the Start Contact button 1304, which will allow the CSR to initiate contact tracking as described earlier. Another option is to select the Jump to Start Screen button 1306, which is a predefined screen that has been configured by the organization as the start screen for CSRs. Yet another option is to select the Call Customer button 1308, which allows the CSR to call the customer back at the indicated number. A CSR may also delete the call if there is no need to log the call or merely cancel to move back to other operations in the CIS product. The received call remains logged in the Caller ID screen 1302 until it is deleted. This allows the CSR to perform any of the functions provided by the option buttons at any time.

In the event that the CSR elects to start a contact, i.e. selection of Start Contact button 1304, a new Customer Tracking screen 1310 is displayed as shown in FIG. 13B. This action also initiates a new contact entry within Customer Tracking. Importantly, the customer's information is filled in on the Customer Tracking screen 1310.

Map View is another application that is tightly integrated into CIS. User organizations that have Map View installed and running on their systems have a tool available to them that allows a map to be pulled up when an account is selected. Screen display 1400 of FIG. 14A illustrates a search window 1402 in which several customer names are displayed. When a particular customer account is selected from the search window 1402, Map View automatically zooms in on that account's physical location on the map. For example, the highlighted account 1404 of “Aaron Jones” has an address of “5775 Yucca Ln”. FIG. 14B illustrates an exemplary view 1406 of a Map that is associated with the selected account 1404 from FIG. 14A. The address associated with the account 1404 selected by the CSR, from the window 1402, will be displayed in the center of the map as indicated by the location 1408 in FIG. 14B—“5775 Yucca Ln”.

This feature is particularly useful for CSRs working with customers that are requesting new services. The CSR is able to quickly find the location where the new service is going in by finding nearby neighbor's locations on CIS then switching to Map View to allow the customer to pinpoint the exact location of the new service. Services are represented as dots 1410 on the map. The setup for this option is provided through the Tools option of Map View. By selecting the “Send Messages to Map view” option, the CIS application can communicate with Map View.

A further option provided to a CSR through the Map View integration, is the ability to have the CSR select the information button (i) on Map View and then high light and click on the dot 1410, to display information on the services for a given location. Turning to FIG. 14C, the display 1412 has several dots representing the services at several locations. The service point window 1414 results from high lighting and clicking on the dot associated with the service at “5775 Yucca Ln.”. The information displayed in the service point window 1414 can also include other services.

Yet another feature of the CIS customer service system is the convenient technical support feature, which allows screen shots and diagnostic information to be linked to electronic mail messages that can be sent to the vendor. From any CIS screen such as display 1500 of FIG. 15A, a user can click on the NISC logo 1502 to create an email message to the vendor's technical support department. In addition, to this feature, if a program error should occur an error screen 1504 is displayed. From the error screen 1504, a user may elect to view more details about the error by selecting the Details button 1506. A user may also select to mail in a work request by selecting the E-mail Work Request button 1508.

Selection of the Detail button 1506 will cause a display of information pertaining to the error, such as shown in the Exception Detail window 1512 on the screen display 1510 of FIG. 15B. The contents of the Exception Detail window 1512 can be copied to the clip boar of the operating environment for transfer to another application program.

When a user selects the NISC logo 1502 or elects the E-mail Work Request button 1508, a typical electronic mail dialog is presented along with an option to include a screen capture. FIG. 15C illustrates a display 1514 having a Support Request window 1516 in which traditional electronic mail fields are provided. Notably, a screen capture selection 1518 is also provided to cause the system of the present invention to attach a screen shot of the user's immediately prior display to be captured and sent to the technical support group of the vendor.

Subscriber Information System

As shown in FIG. 3A, a Subscriber Information System (SIS) is another implementation of the iVUE application. SIS is an integrated, configurable multi-service customer care and operations tool that is directed to the telecommunications industry. Within this implementation of the iVUE product, service orders, service agreements, payment collections and payment adjustments are some of the features that are relevant and specific to the industry and its client base and thus available to a CSR.

As with the CIS product, SIS is a customer centric GUI based system rather than the traditional character and service identification based system. The hierarchical relationship between customer, account and agreement are also maintained in SIS. Specific features of SIS include: carrier and jurisdiction detail; separation of essential services; cross billing of multiple accounts, online payment, data maintenance and extraction for external applications, and service order management.

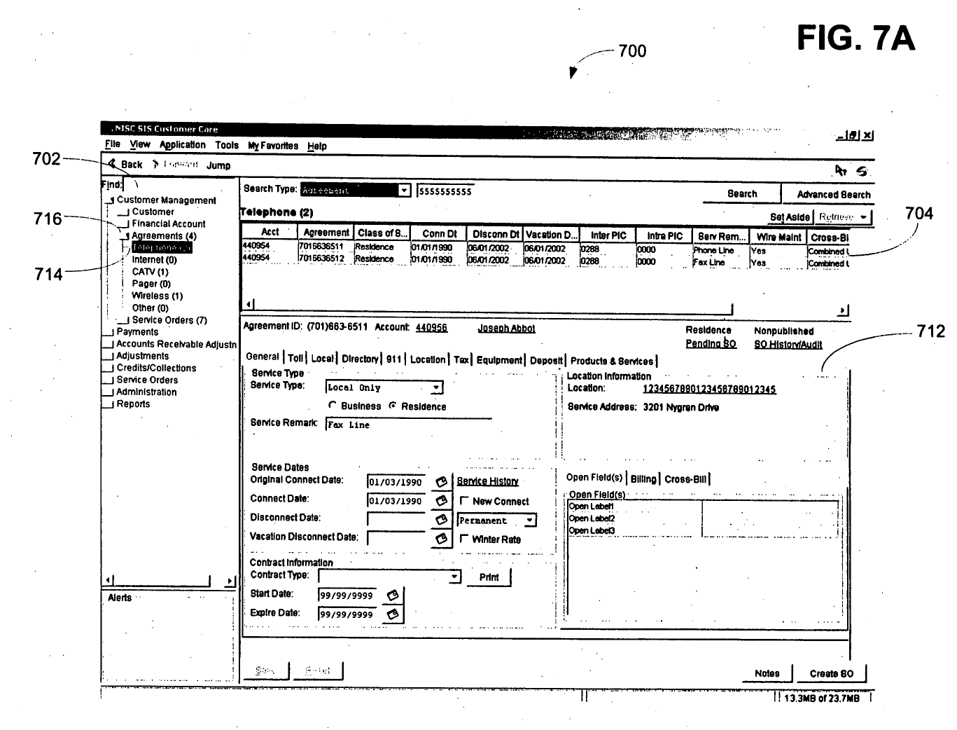

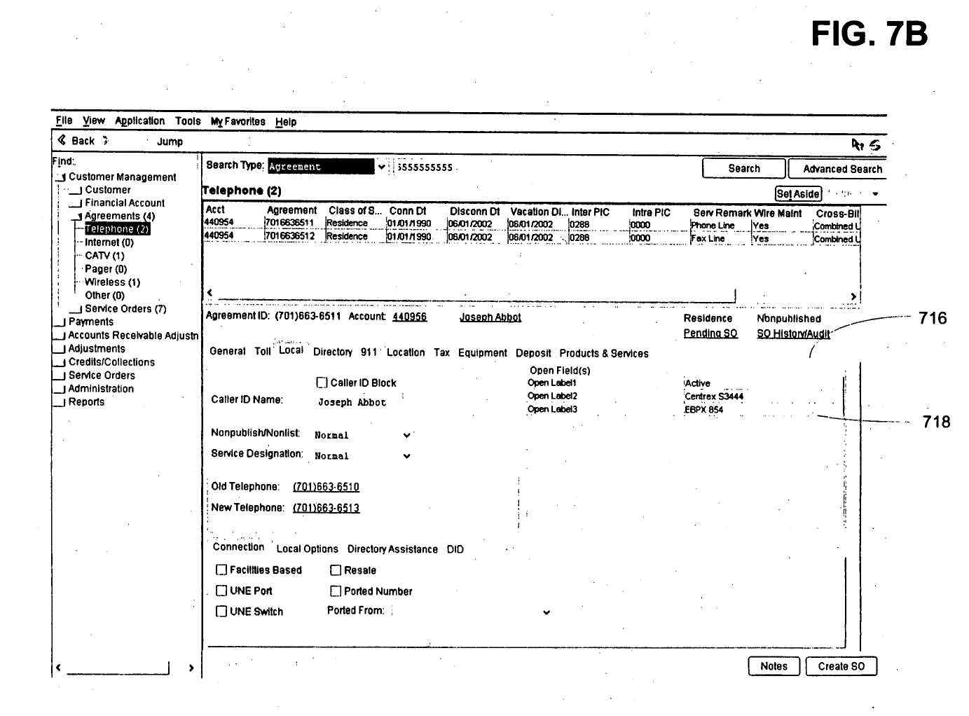

In an exemplary display such as the one shown in FIG. 7A, a screen shot of a user interface that provides access to telephone service is shown and referenced as display 700. As with other displays of the present invention, the display 700 includes a navigation window 702. The display 700 illustrates the result of selecting the ‘telephone’ node 720 from the navigation window 702. It is noteworthy that within the same area of the navigation window 702, the ‘Agreements’ node 720 which is the parent of the telephone node indicates that there are four agreements associated with this particular customer. Specifically and as indicated by the appropriate agreement type, there are two telephone, one cable television and one wireless agreement. In other words, a CSR can tell at a glance how many agreements a particular customer has in addition to telling the types of agreements. When a particular agreement such as the telephone is selected, the summary area displays a table 704 and the content window 712 displays other fields and tabs that are relevant to a telephone type of service. This feature is particularly important in the rural cooperative telecommunication environments.

The table 704 contains two rows of fields summarizing the relevant information for each of the two indicated telephone agreements. Unless the CSR selects differently, the details associated with the first of the two entries in the summary table 704 will be displayed within the content window 712. The content window 712 also displays a number of tabs 714, which are specific to the type of service that has been selected by the CSR, for display. For example, because the current service type is telephone, there are tabs 714 for general information, toll, local, directory information, 911 information, location, tax, equipment, deposit and products. In other words, if the CSR had selected cable television, the displayed tabs 714 may be quite different. Each tab 714 provides quick access to other items of information that are related to the agreement type that is being viewed by the CSR.

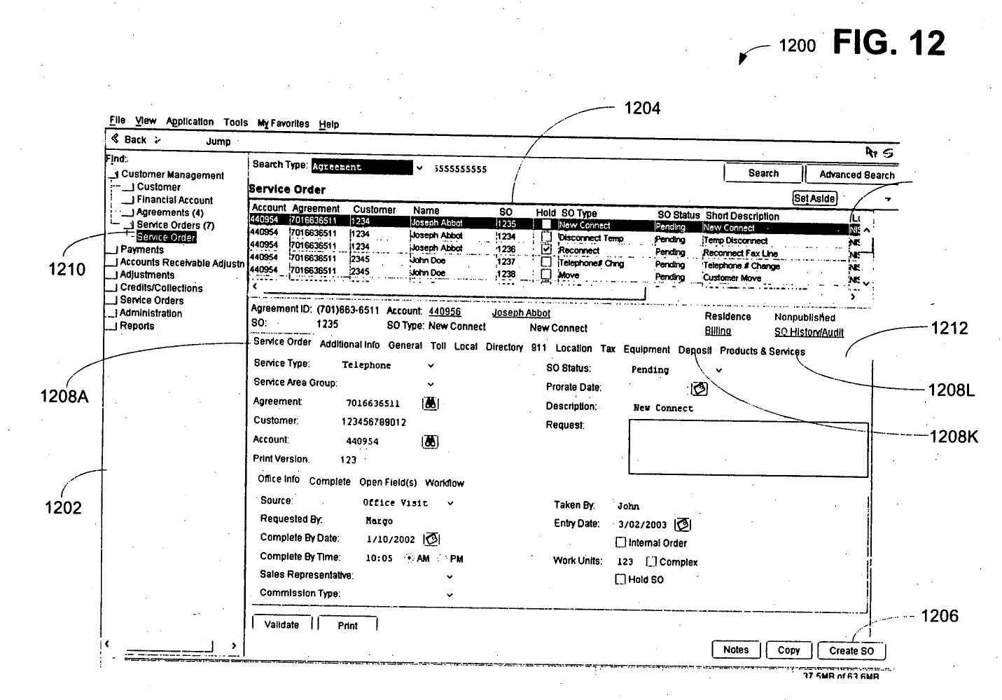

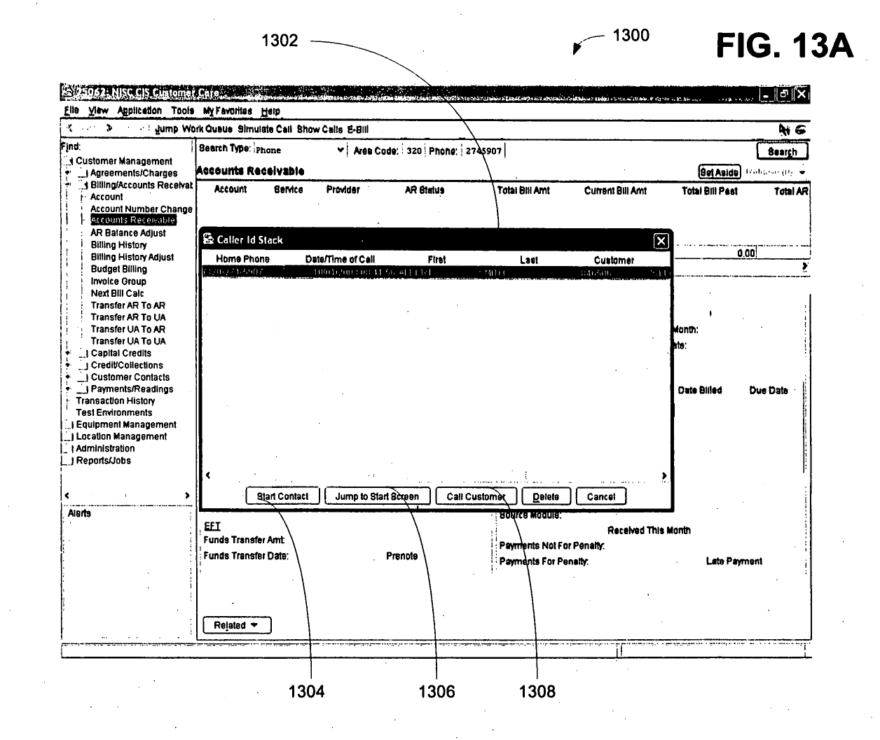

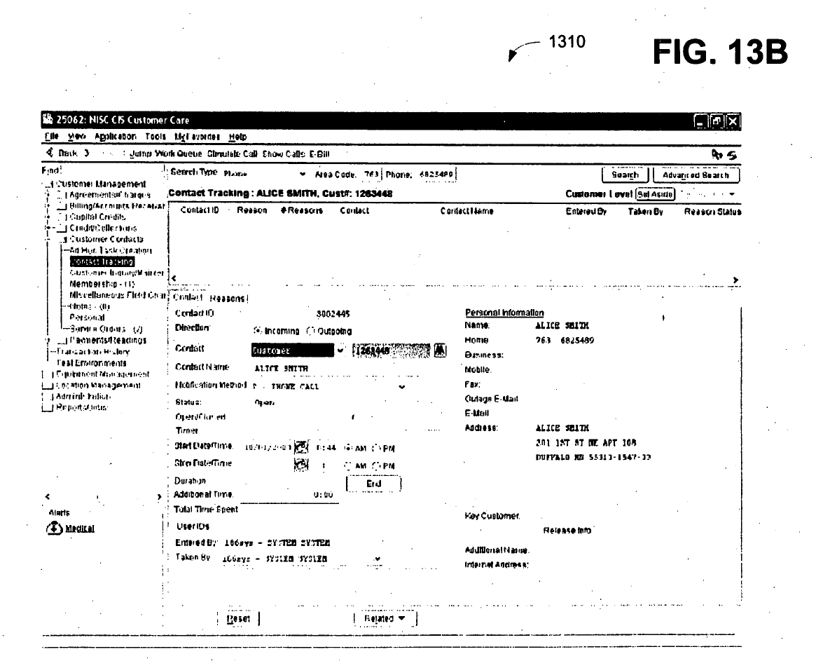

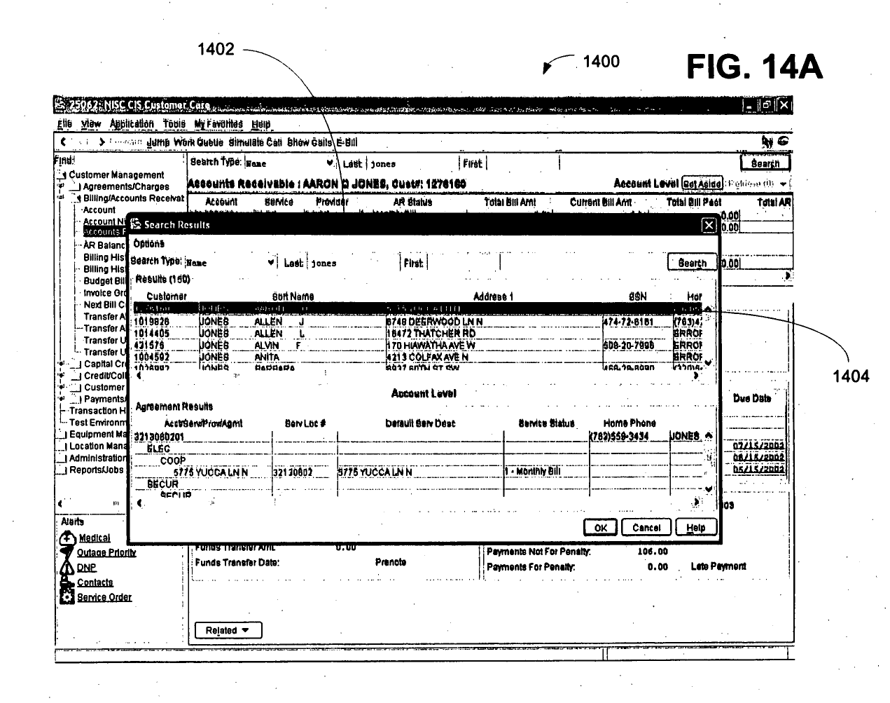

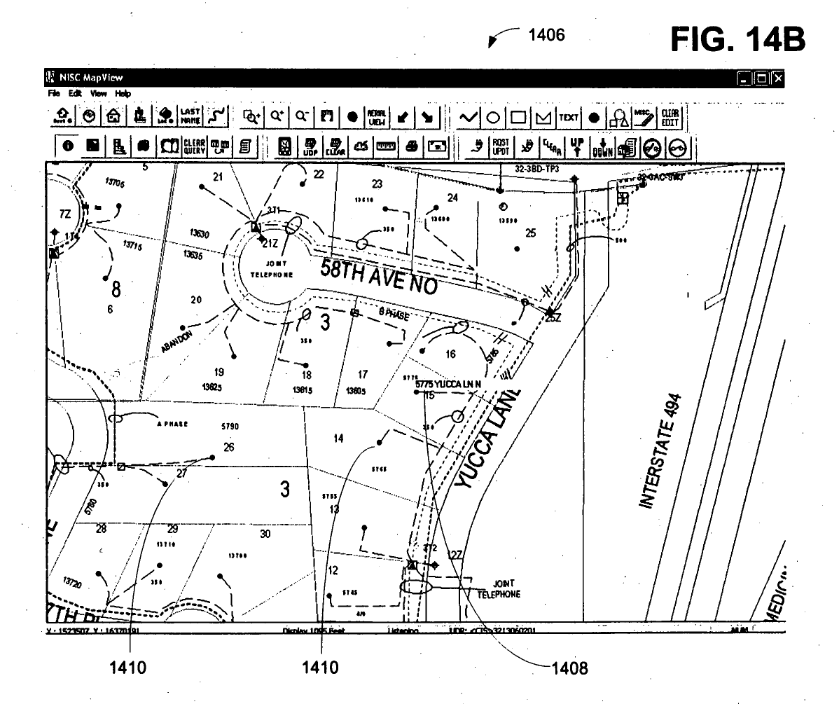

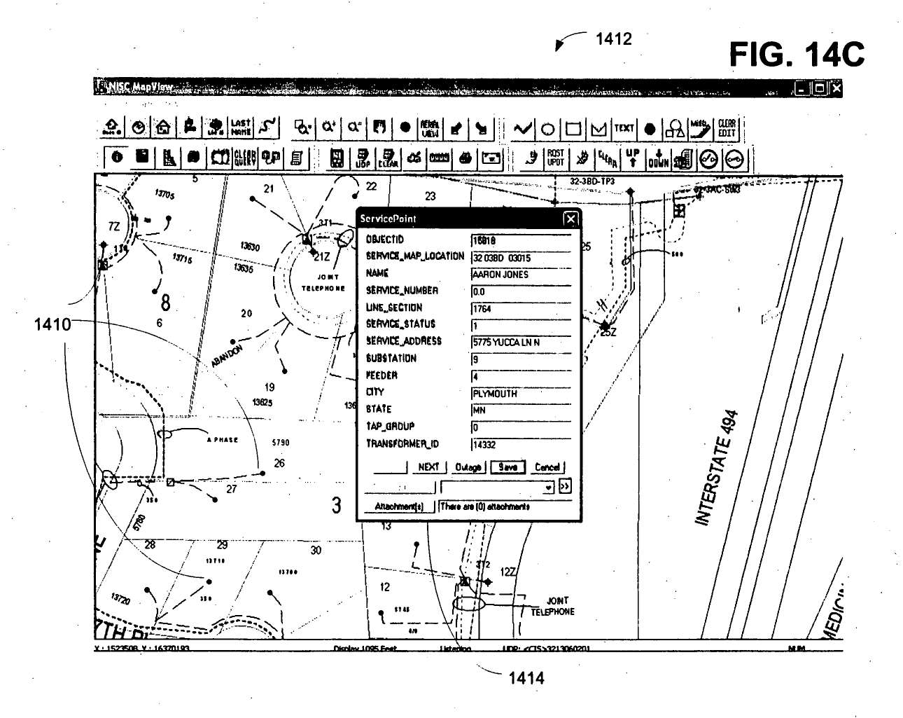

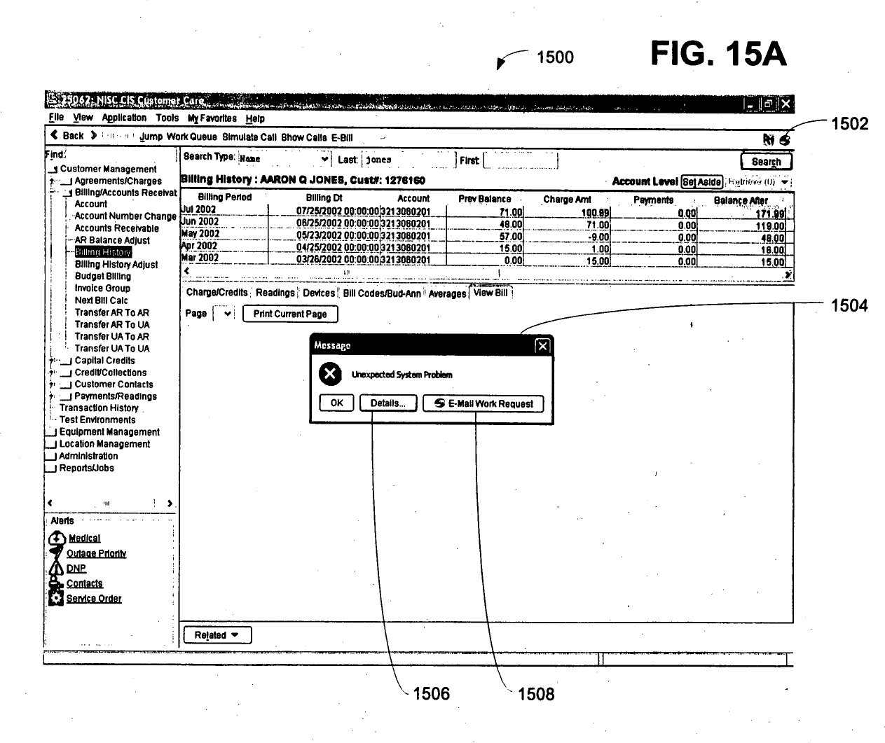

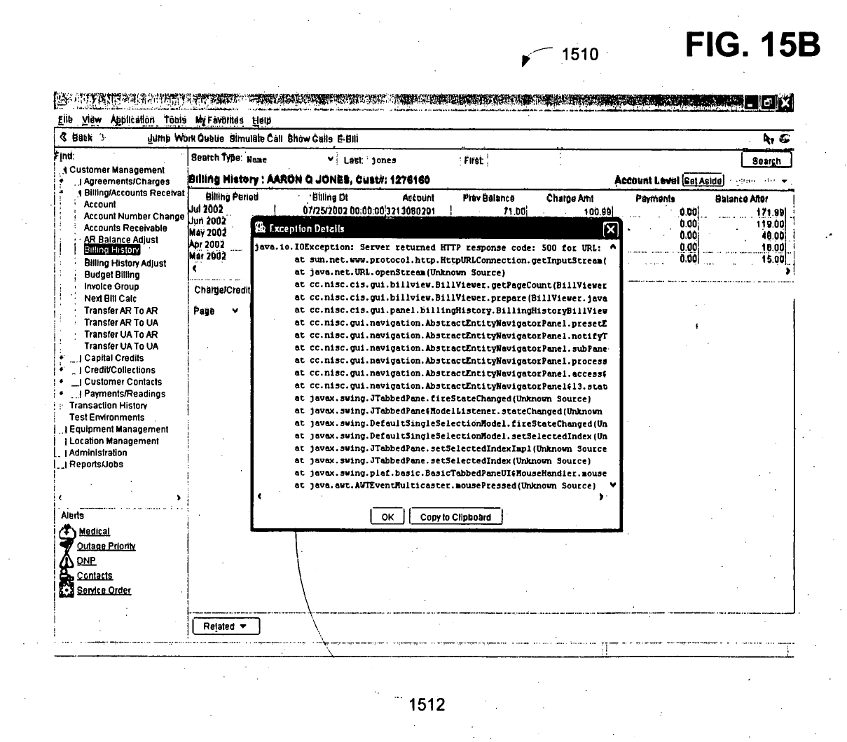

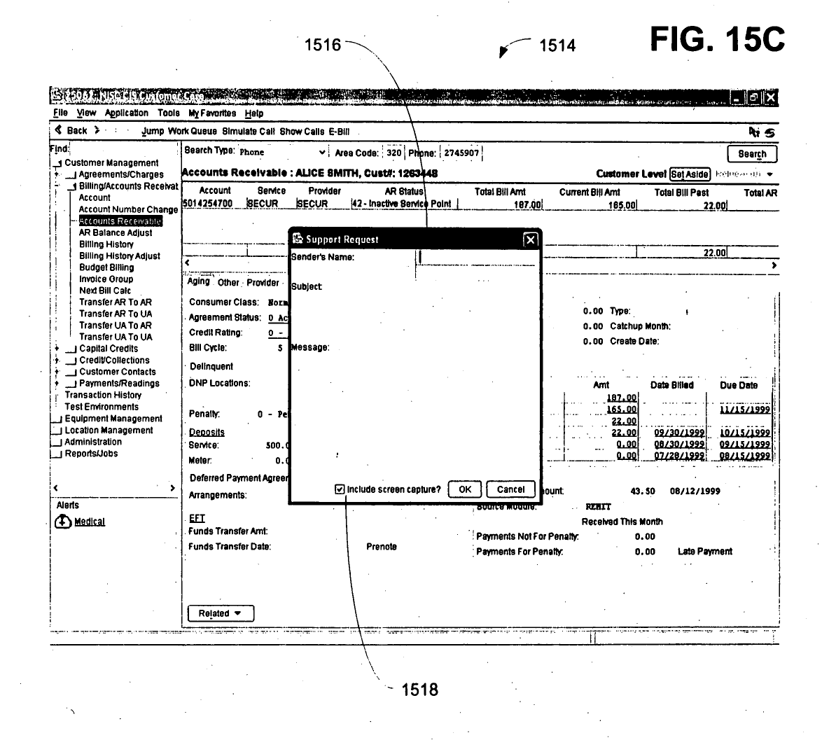

For example, when a CSR selects the Local tab 714, having previously selected a service type of telephone, a new view 716 is shown within the content window 712, as illustrated in FIG. 7B. The view 716 provides access to information and specific properties relating to local options for a telephone service such as, caller Id status, publication of the listing, the option to change the phone number and so on. The access and ability to modify the properties of a service require proper security. The view 716 may also include some user defined open fields 718 as shown, the concept of which was described earlier. The specific access provided by each of the tabs 714 will be discussed with reference to FIG. 12.

FIG. 12 is a screen shot display 1200 of an exemplary user interface that provides access to service orders in an embodiment of the present invention. As with many other features of the present invention, the service order feature is integrated into other features, applications and systems. At the most basic level of this embodiment of SIS, six service types are supported. These are namely, telephone, wireless, internet, pagers, cable TV, and other.

Display 1200, illustrates a typical iVUE customer centric screen with a navigation window 1202, a summary area 1204, and content window 1212. In connection with the windows and areas on the screen, real estate is conserved by the use of hyperlinks that pull up other displays.

Within the navigation window 1202, a CSR would select the sub-node service order 1210 to prompt the display of the summary table 1214 and the view in the content window 1212. In particular, the summary table 1214 provides rows of service orders relating to the accounts and thus agreements of the focus customer. The view of the content window 1212, i.e. the details of a service order, correlates to the selected row of the summary table 1214.

A service order can be created by a CSR or in an alternative embodiment of the present invention, by a customer through an online interface. At any rate, such service order can be viewed by a CSR. Details of a service order can be copied from one agreement to another. For example, the details associated with a service order for one telephone line can be copied to an order for a second telephone line. This is particularly useful for setting service for facilities like a hospital having a plurality of like lines.

The content window 1212 illustrates the details of the first row of the table display 1214. In addition there are several tabs 1208A-1208L shown within the content window, each of which provide access to other pertinent details and information. As described earlier, the number and type of tabs varies by the service type that is being considered. For example, the tabs 1208A-1208L correspond to a telephone type of service. If the CSR were to select CATV as a service type for example, the choice of tabs will change. For example, the toll tab 1208D, directory tab 1208E and 911 tab 1208G would not be displayed. Furthermore, each tab provides access to other salient features of SIS.

To illustrate, the tax tab 1208I provides access to information relating to the tax implementation feature of SIS. In particular, SIS includes the ability to account for and respond appropriately to various tax jurisdictions and their corresponding requirements. For example, in a city such as Bismarck, N. Dak., a telephone service will incur a city tax, county tax and state tax. This may not be the same for a neighboring city. SIS is cognizant of this potential and incorporates the relevant taxes to a customer's account based on the mere identification of a tax jurisdiction.

Also available through the service order feature of SIS is the ability to consider the combined usage of multiple agreements by a customer to meet and obtain discount levels, usage requirements, etc. SIS allows a simplified change of ownership for a given service. Essentially, there is an option that allows an order to be moved, thus requiring less involvement from other units of the telecommunication organization. Previously, in order to change ownership of a service, it was necessary to disconnect the original service and then establish a new service under the new owner. This may have involved various other departments like accounting, engineering, possibly field service personnel and so on.

The product & services tab 1208L allows the merging of local service items or options and their corresponding charges. For example, a single package could be created that incorporates call waiting, call forwarding and caller id. Such packages would be displayed and accessible under this tab. SIS provides a catalog of such products to enable a CSR to quickly determine what is available to a particular customer. SIS also enables a review of the customer's current options.

The deposits tab 1208K provides information on agreements made at the customer level with respect to deposits. For example, it may be the case that there must be a one-month deposit on telephone services, and two months or a fixed amount on CATV. SIS makes such information known to a CSR. In connection with this feature, SIS computes any necessary interest calculations such as, simple interest, compound interest, bimonthly, monthly, quarterly, semi-annually or annually. SIS further facilitates debits and refunds directly to the customer's account via the accounts payable system through check or ACH.

Directory tab 1208F provides access to the feature of SIS that maintains information on the way in which a customer's accounts will be listed and appear in the yellow or white pages. In other words, SIS is able to maintain information that can then be provided to third party systems for the compilation of directory information.

Toll tab 1208D relates to toll services, meaning long distance. Local tab 1208C relates to the local telephone service. SIS treats these two functions separately, thus for example, different disconnect dates can be specified for each service.

On the payment collections and payment adjustment side of SIS, the screen presentations are very similar to those discussed thus far. All screens for example include a summary portion to display all journal entries and allow editing of transactions by selection of the tabular row entries. As such, the discussion will be directed to the features and transactions that are made possible by SIS rather than specific screen displays.

‘With payment’ is a feature that allows rules to be set up on how payment can be applied to aged balances. This particular feature is integrated into the modules for managing cut-off disconnect of non-essential services.

‘Non Pay Reconnects’—From a payment screen, a customer can have their services reconnected when payment is received. In other words, a CSR can initiate actions that will facilitate reconnection when for example a credit card payment is made over the phone. Essentially, a service order of the ‘reconnect type’ would be generated. It was previously the case that all reconnect orders were separately processed. This meant that at the end of day or at predetermined times, all non-pay accounts would be scanned to determine which have been recently paid.

Uncollectable accounts relate to a feature that causes the write-off of a debt to trigger functions that facilitate the transfer of necessary information to a collection agency. Within this module, tax implications are also addressed. For example, adjustments to the taxes that are owed by an organization would be necessary on account of the fact that the tax was never actually collected from the consumer.

Real-time charges and credits take place and effectuate immediate changes in the amounts due on accounts. This feature is particularly useful when dealing with customer Denial of All Knowledge (DAK) calls i.e. a customer claims not to have made a certain phone call. The customer's account and balance due can immediately reflect the credit of those calls. There can be multiple credits and credits can also be applied to multiple agreements. The partial distribution rules discussed earlier can also apply to real time credits.

Balance transfers can be initiated between accounts. Such movement need not be for the same customer. For example, individual A can transfer their bill or account to individual B for the purpose of payments only. This may be useful to cross bill one telephone account to another. Essentially, all bills are sent and assigned or cross-billed to one account. One application for this feature might be when a company is paying the cell phone bills for a number of employees. The employee's telephone account can be cross-billed to the employer's account.

E-Bill presentment and payment is another feature of the customer care package of SIS, aptly called E-customer care. E-customer care provides a web interface to view and pay bills via the internet. The bills have the appearance of paper bills because they are images of the paper bill. An administrative function is provided to cooperative organizations to enable branding of the customer viewed web pages i.e. company logos and other information may be incorporated on the web pages. Also available to consumers within this feature of SIS is the access to select and change options and features pertaining to the customer's accounts and services In the case of provider organizations that have switch provisioning capability, a selection of an option by a customer e.g. caller id, movie selections etc., can be up and running in minutes, without intervention by the organization's personnel.

The various features and screen examples shown and discussed above illustrate the novel features of the customer care system of the present invention. A user of the present invention may choose any of the above features or an equivalent thereof, depending upon the desired application. In this regard, it is recognized that various forms of the subject systems could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawings, the disclosure and the appended claims.

1. A method in a computing environment for providing interaction between a customer service representative and a consumer, the method comprising:
providing a care system having a single point of entry graphical user interface, wherein said care system includes preconfigured links and relationships among one or more screens of said care system;
providing an option to set aside one or more work areas, wherein said set aside option preserves a first set of tasks or features being utilized by said customer service representative, during the performance of a second set of tasks or features; and
said single point of entry graphical user interface comprising, (1) a navigation window, providing a tree display of options for access to a plurality of informational items relating to servicing a focus customer, (2) a search window providing search access to said informational items, (3) an alert window providing pre-configured notifications to the customer service representative (4) a summary area providing provides synopsis of said informational items, and (5) a content area providing details of said informational items.

2. The method of claim 1 further comprising providing one or more customizable fields, that are incorporated into the graphical user interface and informational items of the customer care system.

3. The method of claim 1 wherein said second tasks or features is attending to a second customer.

4. The method of claim 1 wherein said care system is configured for a utility company.

5. The method of claim 4 wherein said care system further provides functions to address deregulation requirements of said utility company.

6. The method of claim 1, wherein said care system is customer centered and provides retrieval, display and grouping of information by customer.

7. The method of claim 1, wherein said navigation window, search window, alert window, summary area and content area are simultaneously presented to the customer service representative.

8. a computer-readable medium having computer-executable instructions for performing the method recited in claim 1.

9. A computer system having a memory, an operating system and a central processor, said processor being operable to execute the instructions stored on the computer-readale medium of claim 8.

10. A computer implemented customer care tool comprising:
a billing information component;
an account management component;
an equipment management component; and
an integrated user interface;
wherein said integrated user interface is customer centered and providing interaction between a customer service representative and said billing component, said account management component, and said equipment management component;
said billing component providing access to billing information of a customer and the charges associated with one or more services provided to one or more accounts of said customer;
wherein said one or more accounts are managed and setup utilizing said account management component;
said equipment management component providing information and access relating to any one or more equipment items associated with providing said one or more services to said customer.

11. The system of claim 10 further comprising a work management component, wherein said work management component provides and receives information from said customer service representative relating to one or more tasks that are to be provided by a service provider.

12. The system of claim 11 wherein said work management component further manages work flows and work queues associated with said one or more tasks.

13. The system of claim 12, wherein said management of work flows entails categorizing of said one or more tasks by assignment, output for end user interaction, and system functions including process initiation or application launching.

14. The system of claim 10 wherein said account management component comprises an account-receivables component, which includes customer status details, payment designation and allocation, and selective posting of payments to multiple providers.

15. The system of claim 10, wherein said account management component comprises a credit-rating component, which includes event tracking and weighting assignments.

16. The system of claim 10, wherein said integrated user interface includes a main navigation tree, hyperlinks, push buttons, and browser-like page forward/page backward functionality.

17. The system of claim 10 further comprising one or more feature and transaction modules.

18. The system of claim 17, wherein said one or more feature and transaction module is a photographic view module for providing displays of customer bills.

19. The system of claim 17, wherein said one or more feature and transaction modules is a seasonal specification module for associating customer addresses with seasonal periods.

20. The system of claim 17, wherein said one or more feature and transaction modules is a training tools for the training of customer service representatives.

21. The system of claim 17, wherein said one or more feature and transaction modules is a caller identification module which integrates caller identification into the customer care tool.

22. The system of claim 17, wherein said one or more feature and transaction modules is a map view module which integrates map viewing into the customer care tool.

23. The system of claim 10 further comprising a technical support component including messaging and exchange of display information and diagnostic data, wherein messaging and exchange occur between a customer service representative and a vendor of said customer care tool.

24. A customer service software system for use by a customer service representative, comprising:
a hierarchy component for classifying the system representation of one or more service items that relate to one or more accounts of a customer;
means for utilizing said classification to organize, present and access information pertaining to said service items; and
an integrated user interface component to present and access information pertaining to said service items, wherein said integrated user interface provides a navigational display for accessing said one or more service items.

25. The system of claim 24 wherein said integrated user interface further comprises a contact tracking component.

26. The system of claim 24 wherein said integrated user interface further comprises an event generation component that initiates of one or more events that are necessary to complete a task selected by the customer service representative.

27. The system of claim 26 wherein said selected task is the addition of a new telephone service and said one or more events includes as necessary, creating a work order for the physical wiring and creating an order for phone poles or other equipment.

28. The system of claim 24, wherein said hierarchy of classification comprises a customer at a first level, one or more accounts at a second level and one or more agreements at a third level, with a one to one or more relationship between said customer and said accounts and a one to one or more relationship between said accounts and said agreements.

29. The system of claim 28 wherein said agreement is for a telephone service.

30. The system of claim 28 wherein said agreement is for a gas service.

31. The system of claim 28 wherein said agreement is for a power service.

32. The system of claim 28, wherein said customer service care system is a utility service care system.

33. The system of claim 28, wherein said customer service care system is a telecommunications service care system.

34. An integrated configurable multi-service customer care and operations tool comprising:
a service order component;
a service agreement component;
a payment collection and adjustment component; and
a customer centric user interface;
said service order component, said service agreement component, and said payment and adjustment component interfaced to said customer centric user interface;
said customer centric user interface providing a hierarchical relationship between a customer, an account and an agreement for providing customer care and managing customer related operations.

35. The system of claim 34 wherein said customer centric user interface includes a navigation window, a summary area and a content window.

36. The system of claim 34 further comprising a security component for monitoring access and rights to various aspects of the customer care and operations tool.

37. The system of claim 34 further comprising user definable fields for recording or displaying customized information.

38. The system of claim 34, wherein said service order component provides support for a plurality of service types including telephone, wireless, internet, pager, and cable television.

39. The system of claim 38, wherein selection of a first service type presents a first number of display tabs; wherein selection of a second service type presents a second number of display tabs; and wherein said display tabs correspond to a view of information items relating to an aspect of the corresponding service type.

40. The system of claim 38 further comprising support for one or more local service items along with the corresponding charges.

41. The system of claim 40, wherein said one or more local service items includes one or more items from the group consisting of: call waiting, call forwarding and caller id, wherein said one or more service items is presented as a display tab.

42. The system of claim 34 further comprising one or more components from a group consisting of, with payment module, non-pay reconnect module, write-off trigger module, real-time charge and credit module, balance transfer module, and e-bill presentment and payment module.

43. A system for providing a customer care graphical user interface comprising:
a customer care computing system having an executable customer care application operably stored thereon where said customer care application is operable to control the computing system to access customer care data relating to general customer data and management data and generate a graphical user interface having a navigation scheme operable to provide a single point of entry user interface where customer information and account information is continuously in view.

44. The system for providing a customer care user interface as recited in claim 43 wherein the management data include reports, billing and work flow data.

45. The system as recited in claim 43 wherein the navigation scheme includes a main navigation tree, hyperlinks, push buttons, and browser-like page forward/page backward functionality.
